(19) United States
(12) Patent Application Publication
(10) Pub. No.: US 2003/0103052 A1
(43) Pub. Date: Jun. 5, 2003

(54) Animation display method in portable electric devices

(76) Inventors: Sayling Wen, Taipei (TW); Zechary Chang, Taipei (TW); Ken Kung, Beijinh (CN)

Correspondence Address: BIRCH STEWART KOLASCH & BIRCH, PO BOX 747, FALLS CHURCH, VA, 22040-0747, US

(21) Appl. No.: 10/000,326

(22) Filed: Dec. 4, 2001

(51) Int. Cl. G06T 13/00; G06T 15/70

(52) U.S. Cl. 345/473

(57) ABSTRACT

An animation display method in portable electric devices is used on a platform with limited memory capacity and can implement the effect of broadcasting large numbers of animations to achieve the objectives of saving memory capacity and repeatedly using animation image elements. The invention comprises: (1) compressing at least one multimedia file through a file compression module; (2) the animation editing module editing the compressed multimedia files and generating an animation file; (3) broadcasting the animation file through an animation broadcast module.

### BACKGROUND OF THE INVENTION

1. Field of the Invention

The present invention relates to an application, and more particularly, to an animation display method in portable electric devices used on a platform with limited memory capacity and implementing an effect of broadcasting a large number of animations.

2. Related Art

With the increasing popularity of computers, people are using them more and more to solve life-related problems, whether at home or at work. With to the progress of hardware devices, the efficacy of computers increases substantially. The so-called multimedia files are generated to meet the requirements of computer users for audio and video applications.

However, animation files occupy the most memory space Animation files have a large number of images, sounds, and text files, so the hardware cannot broadcast them, especially on portable electric devices with little memory space, such as a personal digital assistant (PDA). A plurality of animations implemented on the present PDA is very difficult. This is because common animations occupy a large amount of memory space. If, for example, one animation has 50 pages of images, and one page occupies 40K of memory, for a PDA with only 8 MB of memory, it only can place four animations. This is not enough for computer users. However, animations are always important means to attract computer users to particular software items. If the animations cannot follow users' inclinations, the users will not be interested in the software on these platforms, and will not want to buy the products.

Thus, we need a simple, convenient animation display method in portable electric devices to solve these problems.

### SUMMARY OF THE INVENTION

A primary objective of the invention is therefore to provide an animation display method in portable electric devices to solve the above-mentioned problems.

The claimed invention is an animation display method used in a portable electronic device for integrating multimedia files and displaying animations through modes of compression and file sharing, saving hardware capacity needed by animation, and implement animation effects by a way of plane frame fabrication. The method comprises: (1) compressing at least one multimedia file through a file compression module; (2) the animation editing module editing the compressed multimedia files and generating an animation file; and (3) broadcasting the animation file through an animation broadcast module. The above mentioned portable electronic device is a platform that has limited memory space, which is not enough to broadcast large numbers of animation files.

An advantage of the invention is that the animation display method in portable electronic devices can reduce memory space occupied by the animations, increase manufacturing efficiency, save manufacturing time, and implement a plurality of animations on platforms with little memory space.

Further scope of applicability of the invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The invention will become more fully understood from the detailed description given hereinbelow. However, this description is for purposes of illustration only, and thus is not limitative of the invention, wherein:

FIG. 1 is a diagram of the animation display method in portable electric devices of the invention.

FIG. 2-a is a flowchart of the animation display method in portable electric devices of the invention.

FIG. 2-b is a flowchart of the animation display method in portable electric devices of the invention.

FIG. 2-c is a flowchart of the animation display method in portable electric devices of the invention.

FIG. 3-a is an embodiment diagram of editing animations in the animation display method in portable electric devices of the invention.

FIG. 3-b is an embodiment diagram of editing animations in the animation display method in portable electric devices of the invention.

FIG. 4-a is an operating interface of the file compression module in the animation display method in portable electric devices of the invention.

FIG. 4-b is an operating interface of the animation editing module in the animation display method in portable electric devices of the invention.

FIG. 4-c is an operating interface of the animation broadcast module in the animation display method in portable electric devices of the invention.

### DETAILED DESCRIPTION OF THE INVENTION

The invention provides an animation display method in portable electric devices. The method is implemented by first manufacturing all multimedia files. Next, compress all multimedia files into a compression file and generate an index file to index each file. Edit animations with special tools (what tools and how are they special??). A serial of indexes in the animation files generated by the tool is very small. When broadcasting the animation files, according to the indexes of the animation files and data of the index file, find the animation file from the compressed file. The file is displayed on the screen to form continuous animations.

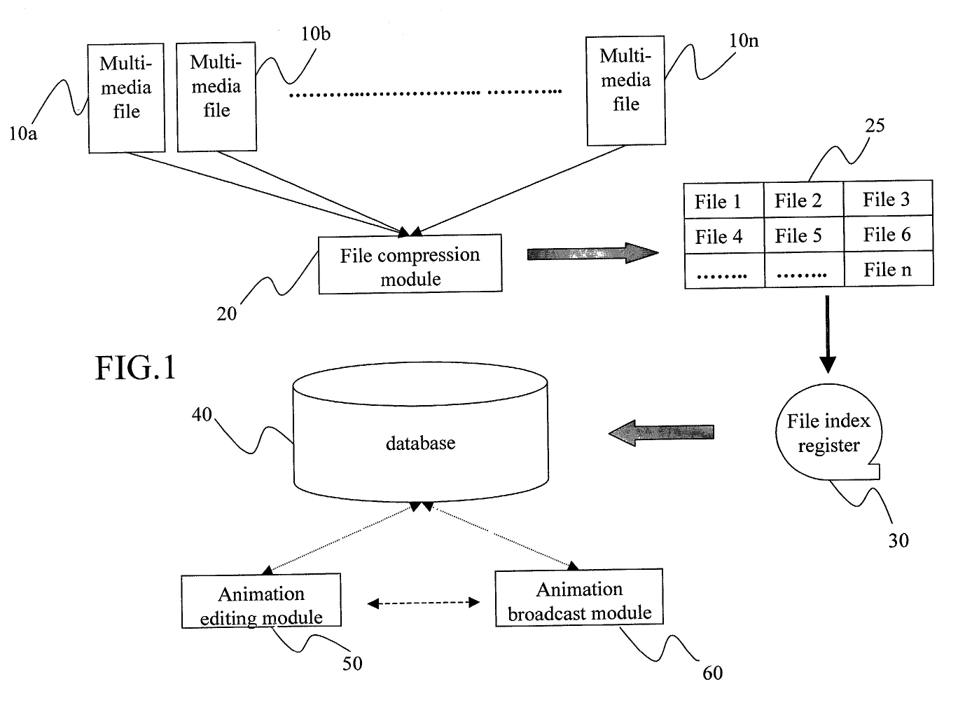

The invention takes a preferred embodiment to describe the feasibility of the method. FIG. 1 is a diagram of the animation display method in portable electric devices of the invention. It introduces the basic structure of the invention as follows:

First, the portable electric device has at least one multimedia file 10a˜10n. It then performs compression through a file compression module. After that, a compression file list 25 is generated to store compressed multimedia files 10. After an index register corresponds the compressed multimedia files 10 into a database 40, an animation editing module 50 integrates the multimedia files 10. The animation files are then displayed through a mode of transforming formats. Finally, through an animation broadcast module 60, broadcast the transformed animation files. The above mentioned multimedia files 10 are file formats that comprise texts, sounds, patterns, and images.

The invention can be executed on a hardware platform of a computer. The portable electric device can be a personal digital assistant (PDA), a cell phone, or other portable electric devices that can broadcast animation files. One who is familiar with the art can perform any changes to implement the animation display method in portable electric devices 100 of the invention into any portable electric devices that can broadcast animation files.

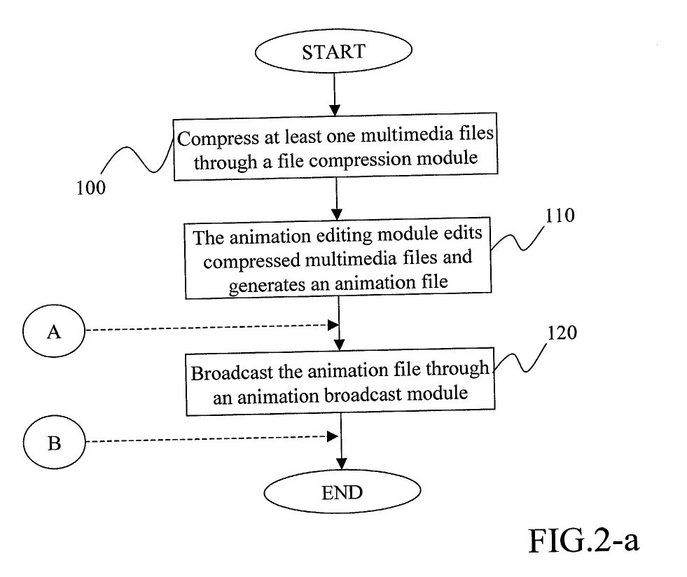

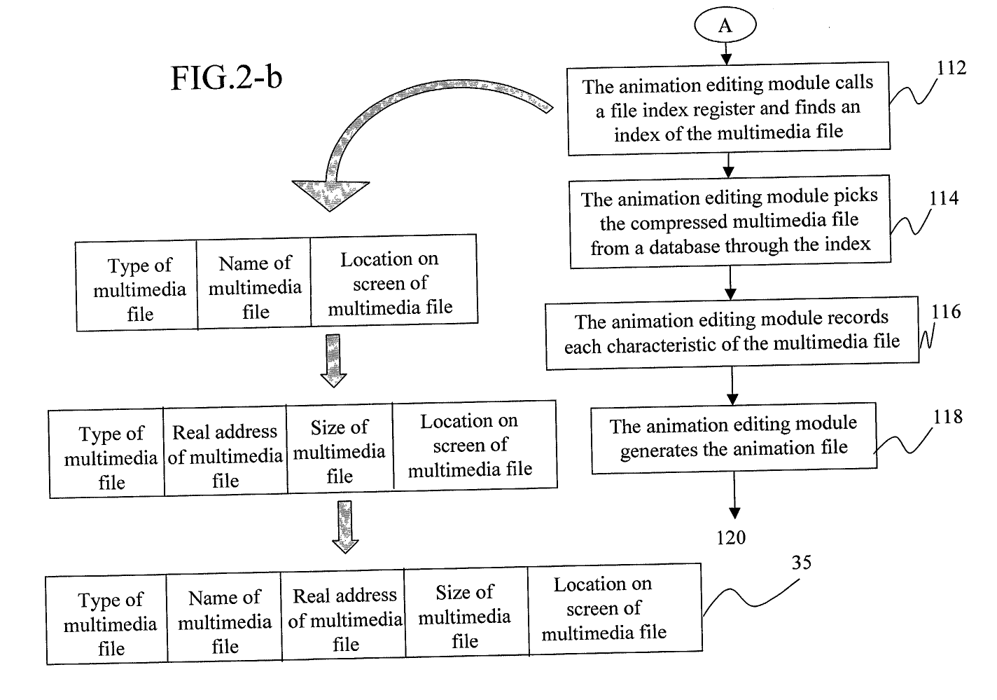

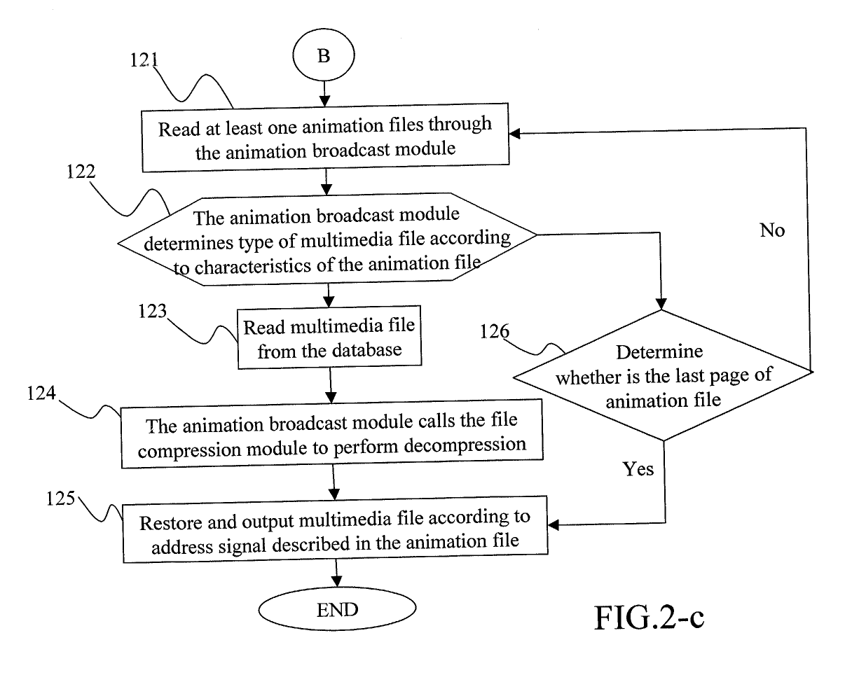

Please refer to FIG. 2-a, which is a flow chart of the animation display method in portable electric devices of the invention. The process is as follows:

First, compress at least one multimedia file 10 through a file compression module 20 (step 100). Then, the animation editing module 50 edits the compressed multimedia files 10 and generates an animation file (step 110). Finally, broadcast the animation file through an animation broadcast module (step 120) and end the process.

The above mentioned file compression module 20 reduces the file storage space through special algorithm processing. It has corresponding functions of compression and decompression, and generates a compression file list 25. The file compression module 20 further comprises a file index register 30. The file index register 30 provides an index file list 35 corresponding to the multimedia files of the compression file list according to an index and stores it in a database 40.

Please refer to FIG. 2-b to see the editing flow of the animation editing module 50. FIG. 2-b is a flow chart of the animation display method in portable electric devices of the invention. The process is as follows:

After step 110, go to step A. First, the animation editing module 50 calls a file index register 30 and finds an index of the multimedia file 10 (step 112). After that, the animation editing module 50 picks the compressed multimedia file 10 from a database 40 through the index (step 114). Next, the animation editing module 50 records each characteristic of the multimedia file 10 (step 116). Finally, the animation editing module 50 generates the animation file (step 118). After generating the animation file, go to step 120.

The above mentioned step 116 transforms the file formats twice through the animation editing module 50 and generates the characteristics of the multimedia files 10. The multimedia files 10 are index file lists for distinguishing different multimedia files 10. The index file lists 35 comprise the following fields:

(1) a type of multimedia file for distinguishing different file formats and attributes and outputting with different ways wherein the type of the multimedia file comprising an audio file and an image file;

(2) a name of the multimedia file for distinguishing different multimedia files through naming by a user;

(3) a real address of the multimedia file as an address of the multimedia file in the database 40;

(4) a size of the multimedia file as the memory space occupied by the multimedia file; and

(5) a location on the screen of the multimedia file as corresponding absolute coordinates on the screen when outputting the multimedia files.

Please refer to FIG. 2-c to see the editing flow of the animation broadcast module 60. FIG. 2-c is a flowchart of the animation display method in portable electric devices of the invention. The process is as follows:

After step 120, go to step B. First, read at least one animation file through the animation broadcast module 60 (step 121). After reading, the animation broadcast module 60 determines the type of the multimedia file according to the characteristics of the animation file (step 122). The type of the multimedia file can be divided into an audio file and an image file. If the result is not either of them, then determine whether it is the last page of the animation file (step 126). If it is not the last page, then go back to step 121. If it is the last page, then go to step 125. If the result is either one of those file types, then read the multimedia file from the database 40 (step 123). After that, the animation broadcast module 60 calls the file compression module 20 to perform decompression (step 124). Finally, restore and output the multimedia file 10 according to an address signal described in the animation file (step 125). The output of the audio file is outputted through basic audio output devices, and the image file is outputted through the multimedia files corresponding to the absolute coordinates on the screen.

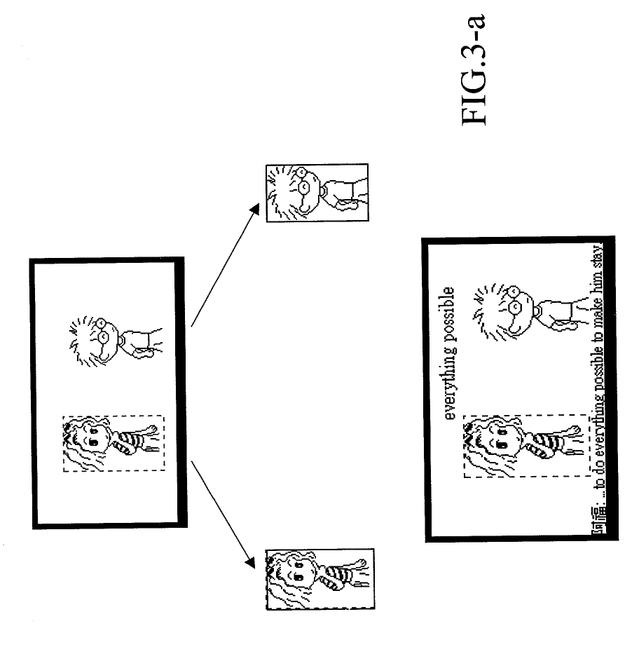

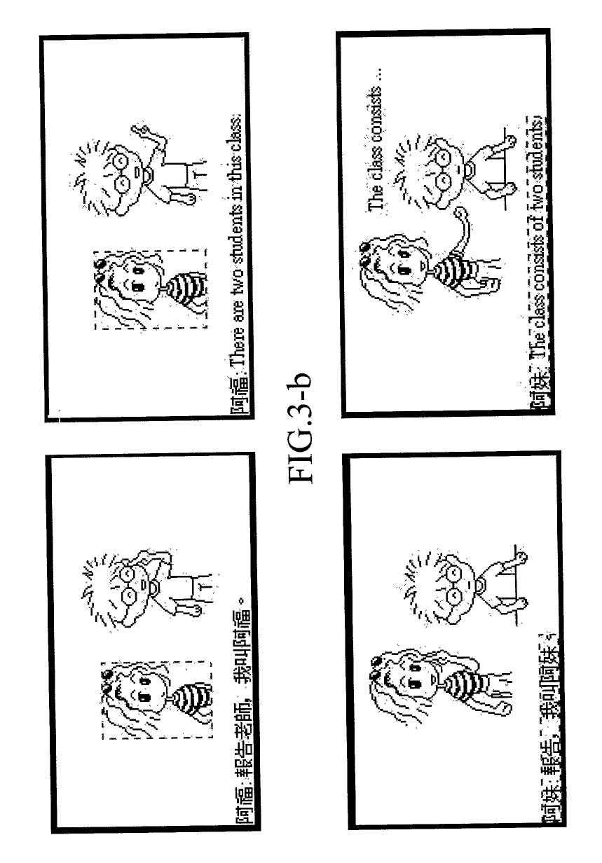

When the animation broadcast module 60 broadcasts the animation files, the multimedia file 10 can be used repeatedly to save memory space. Please refer to FIG. 3-a, which is an embodiment diagram of editing animations in the animation display method in portable electric devices of the invention. Through the preferred embodiment, as shown in FIG. 3-a, from an image file, two basic units of images are provided. When they are used, combine both of the two basic units of images and a text file to form a frame of the animation file. When editing the animations, a unit of image can be used repeatedly, i.e. the units of images in two frames are the same. The more units of the images there are, the less memory space the animations occupy, and space is saved.

Please refer to FIG. 3-b, which is an embodiment diagram of editing animations in the animation display method in portable electric devices of the invention. Continuously broadcast four incompletely same images A plurality of images is combined to form a complete picture, like a cartoon.

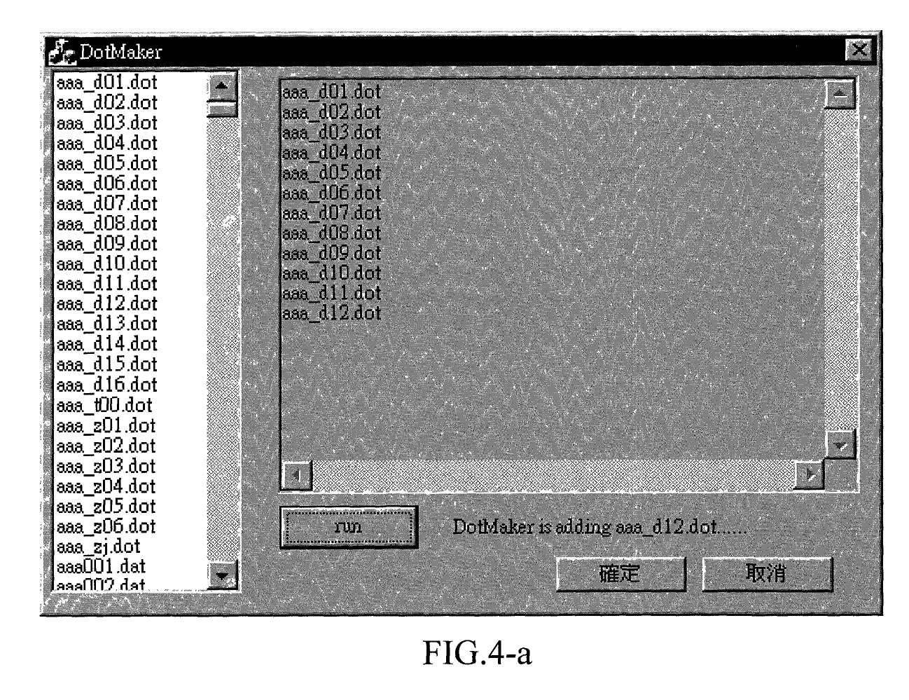

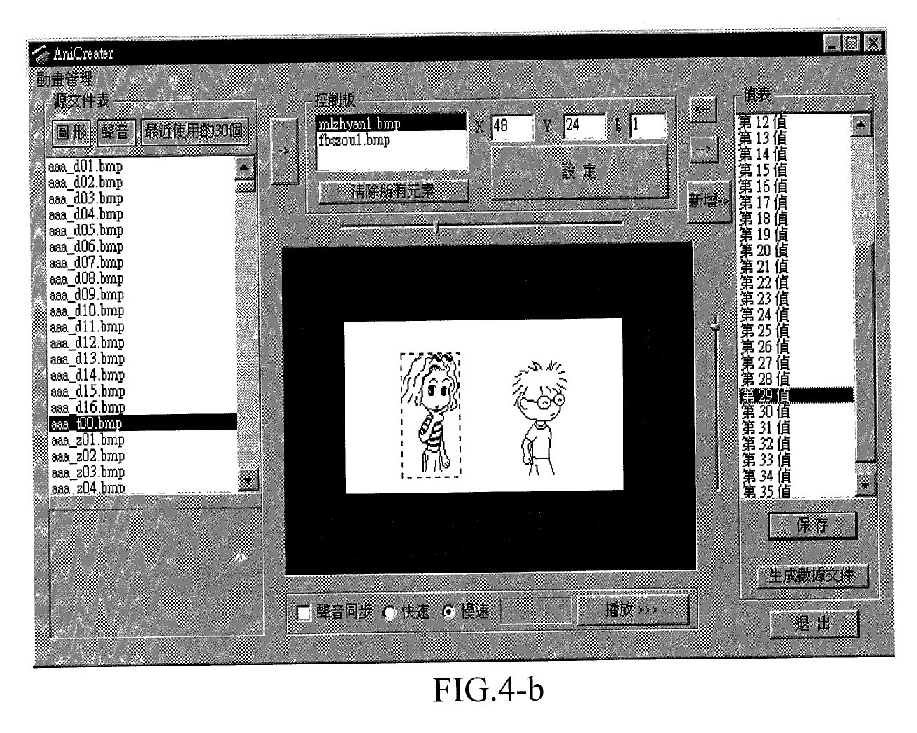

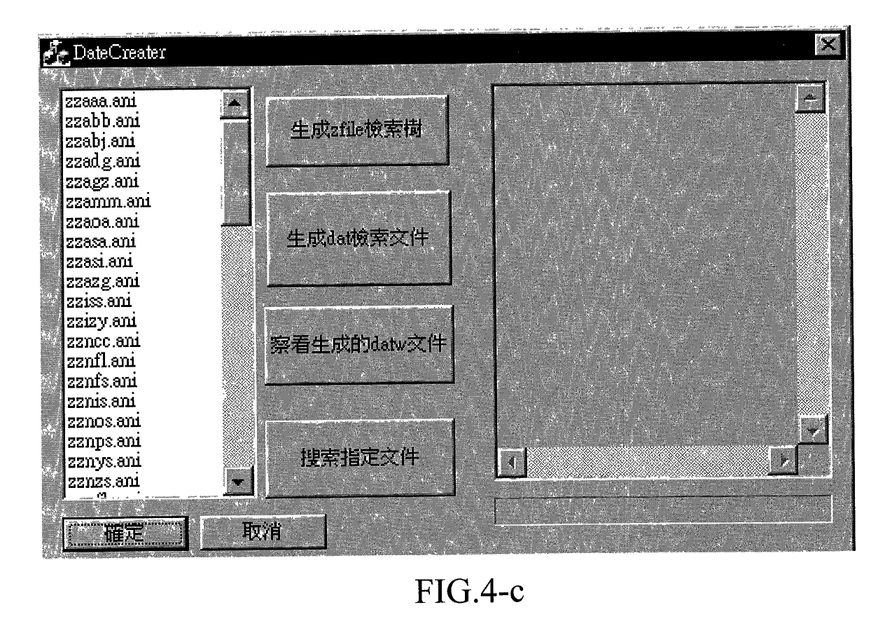

Please refer to FIGS. 4-a, 4-b, and FIG. 4-c. These three figures illustrate operating interfaces of the file compression module in the animation display method in portable electric devices of the invention. FIG. 4-a shows compression tools of the file compression module of the invention. FIG. 4-b illustrates tools for editing animations of the animation editing module in the present invention. FIG. 4-c illustrates animation broadcasting tools of the animation broadcasting module in the invention.

The invention being thus described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An animation display method in portable electric devices used in a portable electric device for integrating multimedia files to display by animation, through modes of compression and file sharing, saving hardware capacity needed by animation, and implement animation effects by a way of plane frame fabrication; the method comprising:
compressing at least one multimedia files through a file compression module;
the animation editing module editing the compressed multimedia files and generating an animation file;
broadcasting the animation file through an animation broadcast module; and
wherein the above mentioned portable electric device is a platform which has limited memory space and not enough to broadcast large number of animation files.

2. The animation display method in portable electric devices of claim 1 wherein the multimedia file is a file format comprising texts, sounds, patterns, and images.

3. The animation display method in portable electric devices of claim 1 wherein the file compression module reduces storage space of files through special algorithm processing, has corresponding functions of compression and decompression, and generates a compression file list, and the file compression module further comprises a file index register.

4. The animation display method in portable electric devices of claim 3 wherein the file index register provides an index file list which is multimedia files corresponding to the compression file list according to an index stored in a database.

5. The animation display method in portable electric devices of claim 1 wherein the animation editing module is used to integrate the multimedia file and display the animation file through a mode of transferring formats.

6. The animation display method in portable electric devices of claim 1 wherein the animation broadcast module is used to broadcast transformed animation files.

7. The animation display method in portable electric devices of claim 1 wherein the step of the animation editing module editing the compressed multimedia file and generating an animation file further comprises:
the animation editing module calling a file index register and finding an index of the multimedia file;
the animation editing module picking the compressed multimedia file from a database through the index;
the animation editing module recording each characteristic of the multimedia file; and
the animation editing module generating the animation file.

8. The animation display method in portable electric devices of claim 7 wherein the step of the animation editing module recording each characteristic of the multimedia file is transformed the file format twice through the animation editing module to generate the characteristics of the multimedia file, and the characteristics of the multimedia file are an index file list used to distinguish different multimedia files.

9. The animation display method in portable electric devices of claim 8 wherein the index file list comprises:
a type of the multimedia file for distinguishing different file types and attributes and outputting with different ways wherein the type of the multimedia file comprises an audio file and an image file; a name of the multimedia file for distinguishing different multimedia files through the name by a user;
a real address of the multimedia file being an address of the multimedia file in the database;
a size of the multimedia file being memory space occupied by the multimedia file; and a location on the screen of the multimedia file being corresponding absolute coordinates on the screen while outputting the multimedia file.

10. The animation display method in portable electric devices of claim 1 wherein the step of broadcasting the animation file through an animation broadcast module further comprises:
reading at least one animation files through the animation broadcast module;
the animation broadcast module determines the type of the multimedia file according to the characteristics of the animation file;
reading the multimedia file from the database;
the animation broadcast module calling the file compression module to perform decompression;
restoring and outputting the multimedia file according to an address signal described in the animation file; and
determining whether is the last page of animation file.

11. The animation display method in portable electric devices of claim 1 wherein the animation broadcast module broadcasting the animation file can uses the multimedia file repeatedly to save the memory space.

12. The animation display method in portable electric devices of claim 1 wherein the animation broadcast module broadcasting the animation file is broadcasting a piece of the multimedia file at a time and achieves an effect of generating animations through continuously broadcasting.

13. The animation display method in portable electric devices of claim 1 wherein the portable electric device can be a personal digital assistant (PDA), a cell phone, or other portable electric devices which can broadcast animation files arbitrarily.
